(19) United States
(12) Patent Application Publication
(10) Pub. No.: US 2016/0179323 A1
(43) Pub. Date: Jun. 23, 2016

(54) IN-PLACE WEB COMMUNICATIONS RELATED TO CONTENT OF A WEBPAGE

(71) Applicant: Avaya Inc., Basking Ridge, NJ (US)

(72) Inventors: Ramanujan S. Kashi, Bangalore (IN); Gaurav Badge, Pune (IN); Thirunavukkarasu Arjunan, Bangalore (IN)

(21) Appl. No.: 14/576,157

(22) Filed: Dec. 18, 2014

(51) Int. Cl. G06F 3/0487; H04L 29/08; G06Q 30/00; H04L 29/06

(52) U.S. Cl. CPC G06F 3/0487; H04L 65/403; H04L 67/02; G06Q 30/016

(57) ABSTRACT

Embodiments described herein provide systems, methods, and computer readable storage media for facilitating an in-place web communication related to content of a webpage. In a particular embodiment, a method provides determining that an indicator is positioned by a user of the user system over a first location on a webpage of a website displayed on the user system and receiving a user selection from the user that requests a communication with an agent system. In response to the user selection, the method provides transferring information associated with the first location to a collaboration system. The collaboration system uses the information to determine a subject matter context for the communication and transfers an indication of the subject matter context to the agent system for use during the communication. Furthermore, the method provides establishing the communication with the agent system via the collaboration system.

### TECHNICAL BACKGROUND

Modern websites allow a user to accomplish a myriad of tasks online from the user's computing device whether the device be a laptop, desktop, smartphone, tablet, or otherwise. These tasks may include retrieving information, purchasing items, creating content, communicating with other users, or any other online activity. In some situations, a user may benefit from assistance when navigating the website. For example, a representative agent for the website may be able to help the user since the agent likely has a greater knowledge of the website than the user.

In order to contact an agent for assistance related to a website, the user would typically have to call an agent using contact information provided by the website. In some cases, the website may be able to direct the user to a generic chat interface. Regardless of which contact method the user chooses, the user will have to explain to the answering agent, or to an automated system that routes the call to the agent, the subject matter about which the user is interested. For example, a website may include many different products, services, or other information with which the user may need assistance. Thus, connecting with an agent having expertise in a particular product or service using current means may be a more difficult process than the user would prefer.

### OVERVIEW

Embodiments described herein provide systems, methods, and computer readable storage media for facilitating an in-place web communication related to content of a webpage. In a particular embodiment, a non-transitory computer readable storage medium having instructions stored thereon is provided. When executed by a user system, the instructions direct the user system to perform a method including determining that an indicator is positioned by a user of the user system over a first location on a webpage of a website displayed on the user system and receiving a user selection from the user that requests a communication with an agent system. In response to the user selection, the method provides transferring information associated with the first location to a collaboration system. The collaboration system uses the information to determine a subject matter context for the communication and transfers an indication of the subject matter context to the agent system for use during the communication. Furthermore, the method provides establishing the communication with the agent system via the collaboration system.

In some embodiments, the method further includes, in response to determining that the indicator is positioned over the first location, displaying a selectable graphical element through which the user selection is received.

In some embodiments, the collaboration system stores a recording of the communication for future access.

In some embodiments, the method further provides, after the communication, displaying the webpage at a second time, receiving the recording of the communication from the collaboration system, and presenting the recording to the user in relation to the first location.

In some embodiments, the method further includes displaying a second webpage of the website on the user system and continuing the communication on the second webpage.

In some embodiments, the method further includes determining that the indicator is positioned by the user over a second location on the webpage and receiving a second user selection from the user that requests a second communication with a second agent system. In response to the second user selection, the method provides transferring second information associated with the second location to the collaboration system. The collaboration system uses the second information to determine a second subject matter context for the second communication and transfers an indication of the second subject matter context to the second agent system for use during the second communication. Moreover, the method further provides establishing the second communication with the second agent system via the collaboration system.

In some embodiments, the communication begins in a first medium. In those embodiments, the method further provides receiving an instruction to change the communication to a second medium and continuing the communication in the second medium.

In a further embodiment, another non-transitory computer readable storage medium having instructions stored thereon is provided. The instructions, when executed by a collaboration system, direct the collaboration system to perform a method including, in response to a user selection from a user of a user system that requests a communication with an agent system, receiving information associated with a first location on a webpage of a website displayed on the user system over which an indicator is positioned by the user. The method further provides determining a subject matter context for the communication using the information and transferring an indication of the subject matter context to the agent system for use during the communication. Additionally, the method provides establishing the communication between the user system and the agent system.

In yet another embodiment, a collaboration system is provided including a communication interface and a processing system. The communication interface is configured to, in response to a user selection from a user of a user system that requests a communication with an agent system, receive information associated with a first location on a webpage of a website displayed on the user system over which an indicator is positioned by the user and transfer an indication of a subject matter context for the communication to the agent system for use during the communication. The processing system is configured to determine the subject matter context using the information and establish the communication between the user system and the agent system.

### BRIEF DESCRIPTION OF THE DRAWINGS

FIG. 1 illustrates a collaboration environment for facilitating an in-place web communication related to content of a webpage.

FIG. 2 illustrates an operational scenario of a collaboration environment for facilitating an in-place web communication related to content of a webpage.

FIG. 3 illustrates a method of operating a user system for facilitating an in-place web communication related to content of a webpage.

FIG. 4 illustrates a collaboration environment for facilitating an in-place web communication related to content of a webpage.

FIG. 5 illustrates an operational scenario of a collaboration environment for facilitating an in-place web communication related to content of a webpage.

FIG. 6 illustrates an operational scenario of a user system for facilitating an in-place web communication related to content of a webpage.

FIG. 7 illustrates an operational scenario of a collaboration server for facilitating an in-place web communication related to content of a webpage.

FIG. 8 illustrates a browser window for facilitating an in-place web communication related to content of a webpage.

FIG. 9 illustrates a browser window for facilitating an in-place web communication related to content of a webpage.

FIG. 10 illustrates a browser window for facilitating an in-place web communication related to content of a webpage.

FIG. 11 illustrates a browser window for facilitating an in-place web communication related to content of a webpage.

FIG. 12 illustrates a browser window for facilitating an in-place web communication related to content of a webpage.

FIG. 13 illustrates a browser window for facilitating an in-place web communication related to content of a webpage.

FIG. 14 illustrates a user system for facilitating an in-place web communication related to content of a webpage.

FIG. 15 illustrates a collaboration system for facilitating an in-place web communication related to content of a webpage.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

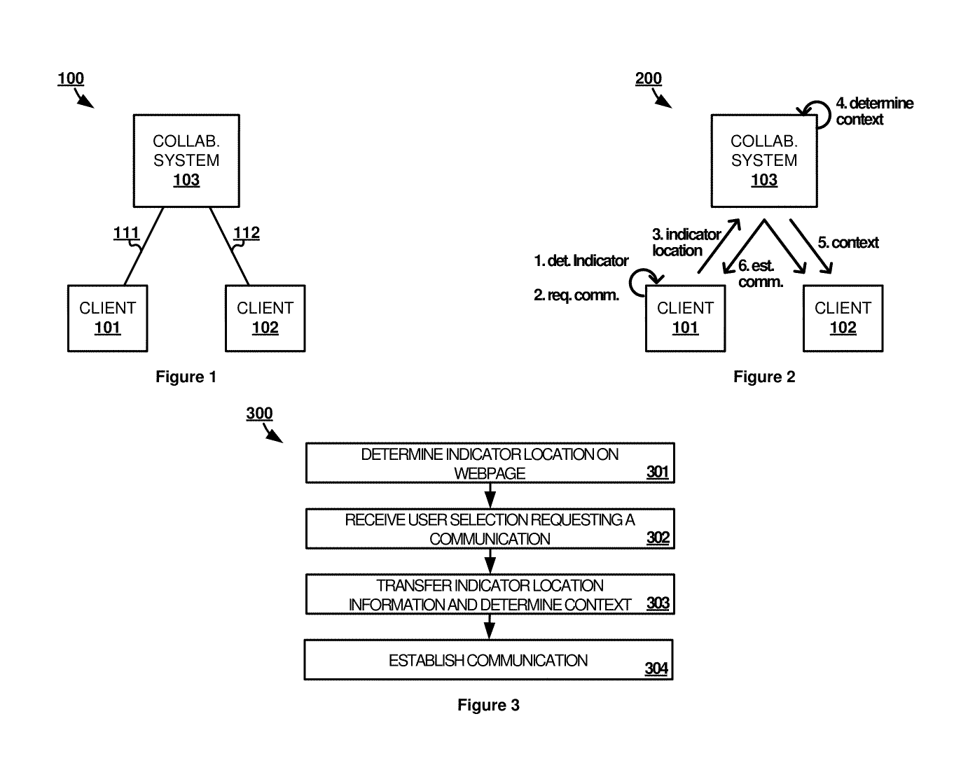

FIG. 1 illustrates collaboration environment 100. Web browsing environment 100 includes user system 101, user system 102, and collaboration system 103. User system 101 and collaboration system 103 communicate over communication link 111. User system 102 and collaboration system 103 communicate over communication link 112.

In operation, user system 101 is a computing system that displays webpages to a user or users. User system 101 may be a desktop computer, laptop computer, tablet computer, smartphone, or some other type of computing device that is capable of displaying webpages through a web browsing application or otherwise. While viewing a webpage, a user of user system 101 may desire additional information about something displayed on the webpage. Instead of giving the user an option to start a communication regarding the webpage as a whole, user system 101 distinguishes different content portions of the website and allows the user to initiate a communication regarding a specific portion of content within the webpage.

For example, the webpage may display multiple different services provided by a business. If user system 101 only gave the user an option to start a communication, such as a text, voice, or video chat session, with an agent for the business at user system 102, then the agent may not know exactly about which of the provided services the user has questions. At best, the agent may know which services are displayed by the webpage that the user is currently viewing. However, the agent will still have to rely on the user to provide the agent with a specific service that the user desires to discuss during the communication.

In contrast, using the embodiments described below user system 101 along with collaboration system 103 will determine which service(s) provided by the business the user is interested in by determining where on the webpage an user indicator is positioned. The agent can therefore be informed about the service of interest to the user. Moreover, the agent may be selected based on the service of interest to the user. Thus, by informing the agent about a particular portion of the webpage that is of interest to the user (e.g. the particular service of the business), the communication can progress more efficiently to assist the user.

It should be understood that while the above example discusses business services displayed by a webpage, the embodiments described herein may apply to webpages having any kind of subject matter. Moreover, while the user of user system 102 is described as an agent for a business or other entity associated with the displayed webpage, the user of user system 102 may be any other type of user with which a web communication may be established.

FIG. 2 illustrates operational scenario 200 of collaboration environment 100 for facilitating an in-place web communication related to content of a webpage. In scenario 200, user system 101 is displaying a webpage to a user. At step 1, user system 101 determines where an indicator is positioned by the user over a location on the webpage. The indicator may be a cursor controlled by a mouse or other pointing device of user system 101, contact by a finger, stylus, or otherwise on a touchscreen of user system 101, or any other way in which the user may position an indicator on a computing system.

At step 2, user system 101 receives a selection from the user requesting a communication with an agent at agent system 102. In one example, user system 101 displays a graphical element nearby the location on the webpage. The selection of this graphical element allows the user to request the communication regarding the subject matter displayed on the webpage at the location. The location may be one of many preset locations on the webpage concerning different subject matter. The graphical element may therefore be displayed nearby the location when the indicator hovers over a predetermined location to allow. Other methods of requested a communication may also be used, such as a keyboard combination, mouse or touchscreen gesture, or any other method for a user to direct a computing device to perform a function.

In response to the user selection, step 3 transfers information associated with the location to collaboration system 103. The information may describe the location on the webpage over which the indicator is positioned, may describe the subject matter at the location on the webpage (e.g. the text presented at the location), may include an identifier for the location, or any other information that, depending on how collaboration system 103 is configured, can be used by collaboration system 103 to determine a subject matter context for the communication—including combinations thereof. The information may be transferred within a request to start the communication or may be transferred separately.

Once received, collaboration system 103 uses the information to determine a subject matter context for the communication at step 4. If the information received from user system 101 explicitly identify the subject matter of the location over which the user positioned the indicator (e.g. explicitly indicating that the location on the website concerns a particular subject matter), then collaboration system 103 simply parses the information to determine the subject matter context for the communication. However, if the information does not explicitly identify the subject matter, then collaboration system 103 may need additional data to identify the subject matter context.

For example, collaboration system 103 may also use a copy of the webpage, either retrieved from the webpage's web server or previously stored in collaboration system 103. If the information received from user system 101 indicates a location on the webpage, then collaboration system 103 can analyze the location on the webpage to determine the subject matter presented at that location. In an alternative example where the information from user system 101 provides a location identifier, collaboration system 101 may maintain a data structure that maps such location identifiers to subject matter displayed on the webpage. Thus, collaboration system 103 references this data structure using the location identifier received from client device 101 to determine the subject matter context for the communication. In yet another example, if the information includes text at the cursor location, then collaboration system 103 may parse the text to identify the subject matter context for the communication. It should be understood that methods for collaboration system 103 to determine the subject matter presented at the location on the webpage other than the examples set forth above may also be used.

After determining the subject matter context for the communication, collaboration system 103 transfers an indication of the subject matter context to agent system 102 at step 5. The indication of the subject matter context may be transferred within a request to establish the communication with agent system 103 or may be transferred separately. In some examples, collaboration system 103 may select the agent operating user system 102 for the communications from a plurality of agents based on the subject matter context. That is, the agent at user system 102 may be best suited to currently handle a communication over the subject matter identified by the subject matter context.

Step 5 establishes the requested communication between user system 101 and client device 102 via collaboration system 103. Since the agent at user system 102 has been informed of the subject matter context of the communication, the agent can more efficiently handle the communication with the user of client device 101. In some examples, a window for the communication may be presented over the webpage nearby the location so as to associate the communication with the subject matter of the webpage at the location. Thus, even if multiple communications are established for different items of subject matter presented in the webpage to the user, the user can differentiate the communications based on where the windows for each of the communications are displayed over the webpage.

FIG. 3 illustrates a method 300 of operating of user system 101 for facilitating an in-place web communication related to content of a webpage. Method 300 provides determining that an indicator is positioned by a user of user system 101 over a first location on a webpage of a website displayed on user system 101 (step 301). The indicator may comprise any possible means for indicating a position on a website using a computing device, such as a mouse pointer, touchscreen, or otherwise. Method 300 also provides receiving a user selection from the user that requests a communication with an agent system 102 (step 302). The user selection may be made using the same indicator that is used in step 301 and may be performed by any possible means for making a selection on a computing device, such as a mouse button click on a graphical button, a touchscreen tap on graphical button, a keyboard button press or sequence of button presses, a mouse or touchscreen gesture, or otherwise.

In response to the user selection, method 300 provides transferring information associated with the first location to collaboration system 103 (step 303). The information may be transferred with a communication request or at another time, such as after the communication has been established. Collaboration system 103 uses the information to determine a subject matter context for the communication and transfers an indication of the subject matter context to agent system 102 for use during the communication. That is, by transferring the indication of the subject matter context, collaboration system 103 is able to inform the agent at agent system 102 with the subject matter context about which the user of user system 101 wants to communicate. Method 300 further provides establishing the communication with agent system 102 via collaboration system 103 (step 304).

Method 300 may be performed by user system 101 at the direction of software instructions executing thereon. The instructions may be transferred to user system 101 within the data of the first webpage. For example, the instructions may be included in HTML5 code for the webpage, within a Java code of the webpage, Flash code of the webpage, or otherwise. Alternatively, the instructions may be part of a web browser extension, an independent web communication client, or any other type of software that a computing device may execute—including combinations thereof.

Referring back to FIG. 1, user systems 101 and 102 each comprise computer processing circuitry and communication circuitry. The communication circuitry may be wireless, wireline, or both. User systems 101 and 102 may each also include a user interface, memory device, software, or some other communication components. User systems 101 and 102 may each be a telephone, computer, e-book, mobile Internet appliance, media player, game console, or some other computing apparatus—including combinations thereof.

Collaboration system 103 comprises a computer system and a communication interface. Collaboration system 103 may also include other components such a router, data storage system, and power supply. Collaboration system 103 may reside in a single device or may be distributed across multiple devices.

Communication links 111-112 use metal, glass, air, space, or some other material as the transport media. Communication links 111-112 could use various communication protocols, such as Time Division Multiplex (TDM), Internet Protocol (IP), Ethernet, communication signaling, CDMA, EVDO, WIMAX, GSM, LTE, WIFI, HSPA, or some other communication format—including combinations thereof. Communication links 111-112 could be direct links or may include intermediate networks, systems, or devices.

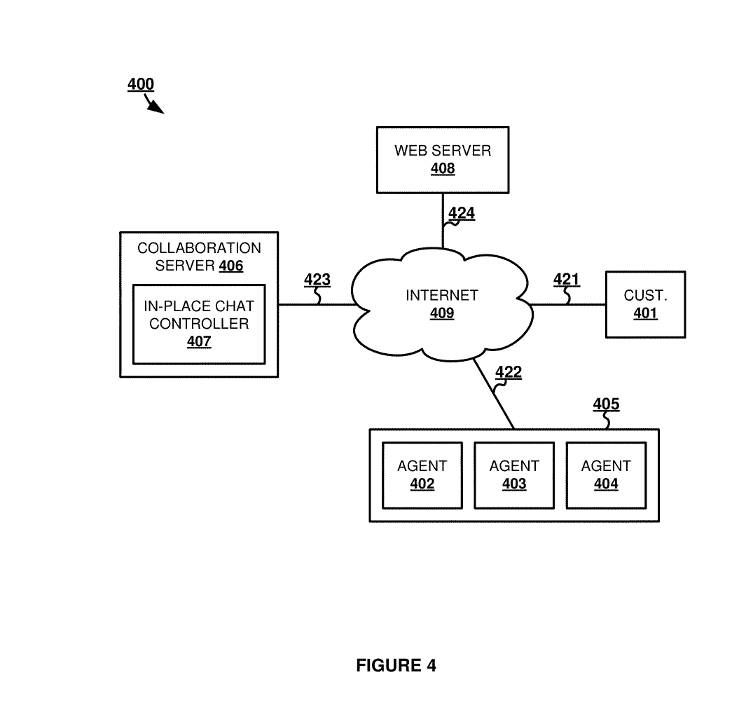

FIG. 4 illustrates collaboration environment 400. Collaboration environment 400 includes customer system 401, agent systems 402-404 located within support center 405, collaboration server 406, web server 408, and Internet 409. Collaboration server 406 includes in-place chat controller 407. Customer system 401 and Internet 409 communicate over communication link 421. Support center 405 and Internet 409 communicate over communication link 422. Collaboration server 406 and Internet 409 communicate over communication link 423. Web server 408 and Internet 409 communicate over communication link 424.

Web server 408 comprises a computer system and communication interface. Web server 408 may also include other components such a router, data storage system, power supply, and any further components that may be used for providing websites to web browsing applications. Web server 408 may reside in a single device or may be distributed across multiple devices.

While shown separately, web server 408 and collaboration server 406 may be incorporated within one another or may be collocated such that they communicate over a local area network rather than Internet 409. Similarly, support center 405 and either web server 408, collaboration server 406, or both may be collocated. Alternatively, support center 405 may be a virtual center with agent systems 402-404 distributed in multiple locations and accessing Internet 409 on separate links. Additionally, customer system 401, support center 405, collaboration server 406, web server 408 may access Internet 409 through one or more access providers.

In operation, agents operate agent systems 402-404 to assist customers or, some other type of user, with issues that the customer may have. In some embodiments, support center 405 may be associated with an entity from which the customer requires support. For example, web server 408 may include a website for a company and support center 405 provides support to customers using the company's website. If necessary, collaboration server 406 may be used for an agent operating one of client devices 402-404 to provide the customer with website support.

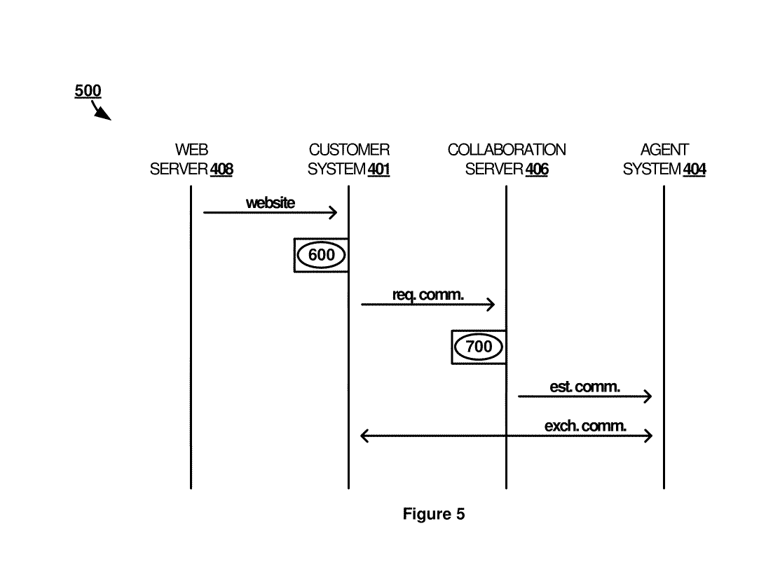

FIG. 5 illustrates operational scenario 500 for collaboration environment 400 to facilitate an in-place web communication related to content of a webpage. In scenario 500, the customer using customer system 401 navigates a web browser of customer system 401 to a webpage of a website by requesting the webpage from web server 408. In response, web server 408 provides the webpage data to customer system 401. The webpage data in this example includes the instructions necessary for customer system 401 to facilitate an in-place web communication regarding the content of the webpage.

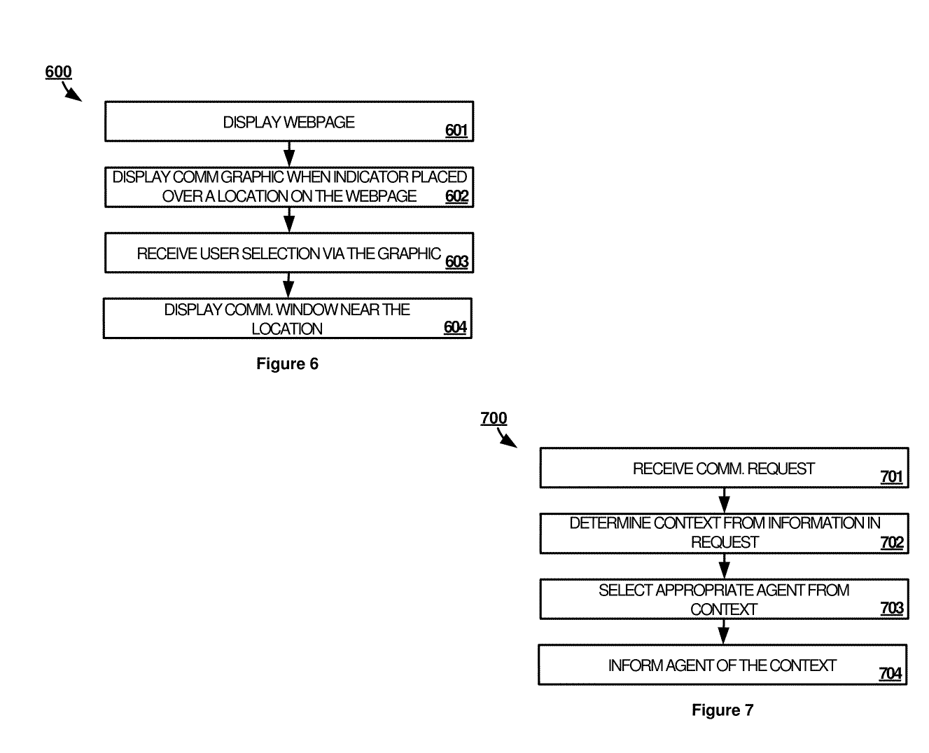

Upon receiving the webpage data, customer system 401 performs operation 600 illustrated in FIG. 6. Specifically, customer system 401 renders the webpage data and displays the webpage to the customer (step 601). While viewing the webpage, the customer positions a cursor of customer system 401 over a location on the display of the webpage corresponding to subject matter of interest to the customer. Upon determining that the cursor is hovering over the location, customer system 401 displays a graphic over the webpage near the location that allows the customer to initiate a communication with a customer service agent if so desired (step 602). More specifically, the graphic may ask the customer if they would like to start a communication regarding the subject matter presented at the location.

Since the customer does want to initiate a communication in this example, customer system 401 receives a selection via the graphic indicating that the user would like to start a communication (step 603). In some embodiments, the graphic may provide more than one mode of communication, such as text chat, audio call, or video call, from which the user can select. After receiving the selection, customer system 401 displays a communication winder near the location on the webpage that will be used to facilitate the communication (step 604). The communication window may be displayed immediately upon requesting the communication or at a later time, such as when the communication has been established with an agent system.

Referring back to FIG. 5, customer system 401 transfers a communication request to collaboration server 406 to start the communication with an agent system. The communication request indicates information associated with the location of the webpage over which the customer positioned the cursor. The information may explicitly identify the subject matter presented at the location or may contain enough information for in-place chat controller to determine the subject matter on its own. Upon server 406 receiving the communication request, in-place chat controller 407 performs operation 700 illustrated in FIG. 7.

In operation 700, in-place chat controller 407 receives the communication request and the information from customer system 401 (step 701). In-place chat controller then determines a subject matter context for the communication from the information with the request (step 702). Specifically, in-place chat controller uses the information to determine the subject matter presented on the webpage at customer system 401 over which the user placed the cursor.

Once the subject matter context has been determined for the communication, in-place chat controller 407 selects to which of the agent systems 402-404 should be routed based on the subject matter context (step 703). That is, each agent operating each respective agent system may be suited to handle communications regarding different subject matter. Thus, in-place chat controller 407 selects the agent operating agent system 404. After selecting agent system 404, in-place chat controller 407 notifies the agent of the subject matter context for the communication (step 704). The notification may be transferred along with a request to setup the call with agent system 407 or in a separate message. In some cases, the agent may only handle calls regarding the subject matter of the communication and, therefore, the subject matter context of the communication is implied by the fact that the agent is receiving the call.

Once again referring back to FIG. 5, collaboration server 406 transfers a request to establish the communication with agent system 404. Then, upon acceptance of the request by agent system 404, customer system 401 and agent system 404 are able to exchange communications via collaboration server 406. In particular, the customer at customer system 401 uses the chat window opened at step 604 to exchange communications. The chat window is near the originally indicated position on the webpage to maintain a subject matter association visually for the user during the conversation.

In some embodiments, the communication mode of the communication may change during the communication at the request of the agent or the customer. For example, the chat window may initially display text-based communications but then the customer may request voice communications. Collaboration system 406 may then switch the communication mode to voice from text and display some indicator of the voice communications in the chat window instead of the text chat messages.

In further embodiments, the customer may hover the cursor over a different location presenting a different subject matter. Operational scenario 500 may then repeat using this new location. The new location may result in a communication established with an agent at agent system 402 that is displayed in a new window nearby the new location. Alternatively, the communication may also be with agent system 404. The new window may be displayed in addition to the window for the original communication. Thus, even if the communications are both with the same agent, the customer can differentiate the subject matter of each communication based on the disparate window locations over the webpage.

Collaboration server 406 may further record the communication and store it in a storage system in association with the customer. The communication may be associated with the customer based on a web account for the customer, browser history tracking, website cookies, or some other means of associating a web activity with a particular customer, web browser, or computing system. The customer may then access the communication at a later time upon revisiting the website. For example, the customer may reload the webpage on customer system 401 a day after the communication above. When customer system 401 displays the graphic at step 602, the graphic may further allow the customer to request retrieval of the recorded communication from collaboration server 406 for the previous day. Other means of requesting a recorded communication could also be used.

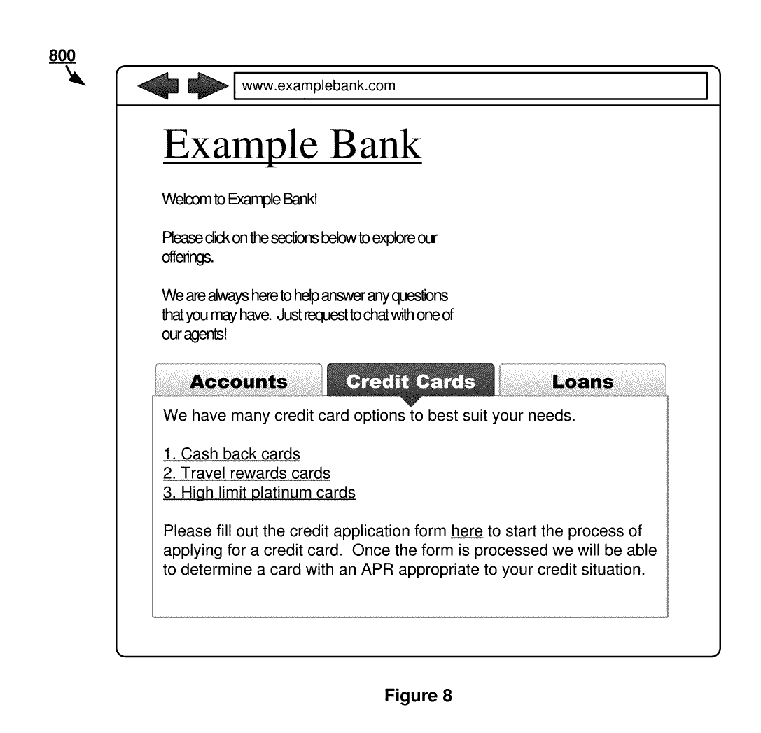

FIG. 8 illustrates web browser window 800 in an example of facilitating an in-place web communication related to content of a webpage. Web browser window 800 is an example of the webpage displayed on customer system 401 in the above operational scenario 500. In this example, the customer at client device 401 trying to explore the offerings of Example Bank on their website, www.examplebank.com, as displayed in web browser window 800. Furthermore, Example Bank's website data received from web server 408 includes the instructions necessary to facilitate customer system 401's functions in operational scenario 500.

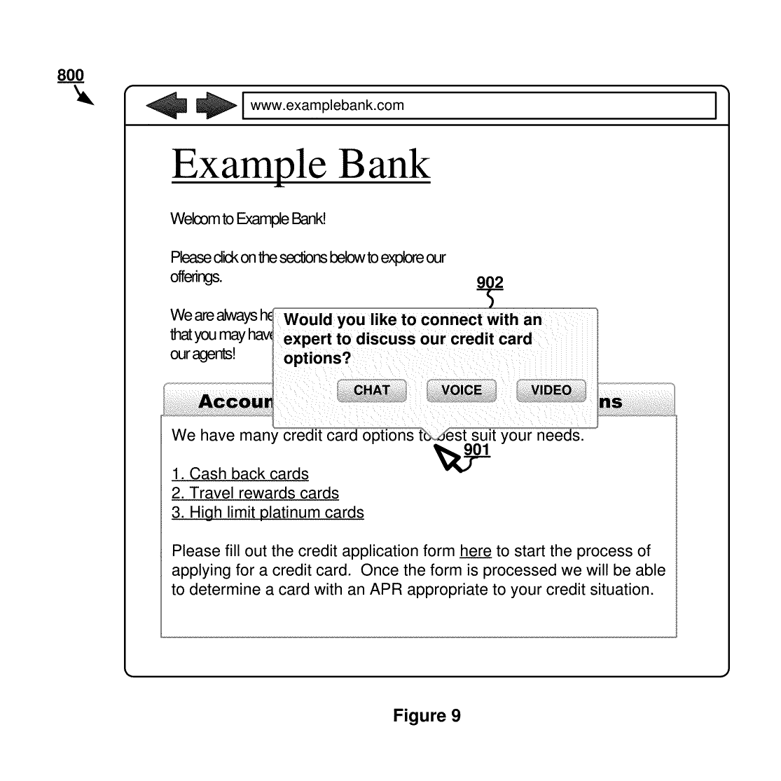

FIG. 9 illustrates web browser window 800 having cursor 901 positioned by a user via a mouse over the Example Bank webpage being displayed. As noted above, other means of positioning an indicator may be used instead. In this example, cursor 901 is positioned over wording on the website noting that Example Bank offers many credit card options. Then user system 401 using the operations described herein, either by itself or by sending information about the location of cursor 901 to collaboration server 406, determines that the subject matter over which cursor 901 is positioned relates to credit card offerings. Accordingly, user system 401 displays a graphic 902 nearby the location of cursor 901 asking the user whether they would like to start a communication with an agent to discuss the credit card options. The credit card options being the subject matter context of the communication should the user desire.

Graphic 902 may be displayed as soon as user system 401 determines the subject matter for the location of cursor 901, may be displayed after cursor 901 has hovered over the location for a predetermined period of time (e.g. 0.5 seconds), or upon some other triggering event. Additionally, while graphic 902 displays three possible modes of communication, text chat, voice, and video, the communication modes may vary depending on the capabilities of collaboration server 406 or agent systems 402-404. For example, some systems may only allow for text and voice communications but not video. Furthermore, communication modes other than text chat, voice, or video may be offered. For example, a user may be given the option to leave a message rather than participate in a real-time communication. An agent can then respond to the message at a later time.

It should be understood that any number of possible subject matter items may be determined from the webpage displayed in window 800. In one example, different subject matter may be determined when cursor is positioned near each respective tab accounts, credit cards, and loans. In other cases, more granular subject matter may be determined. For example, the subject matter may be determined as one of cash back cards, travel rewards cards, or high limit platinum cards if cursor 901 were positioned over the links for each of those offerings.

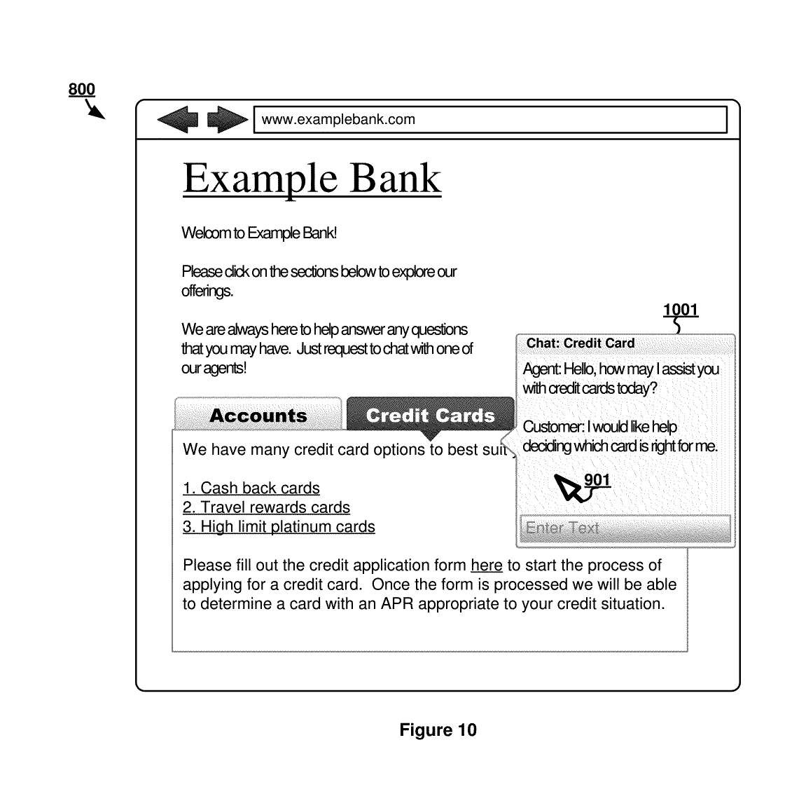

FIG. 10 illustrates web browser window 800 upon the user selecting the text chat option from graphic 902. Specifically, upon receiving the selection to start the text chat communication, chat window 1001 is displayed over the webpage in window 800. Chat window 1001 is positioned nearby the location of cursor 901 which caused the initial determination of subject matter for the communication. This positioning of the chat window near the location is to further assist the user in recognizing the subject matter context of the communication in the window, that context being credit card offerings.

Before the chat began in window 1001 information used by collaboration server 406 to select an agent and/or provide the subject matter context to the agent is transferred from customer system 401 to collaboration server 406. If collaboration server 406 did not assist in determining the subject matter for display in graphic 902, then customer system 401 may transfer an indication of the subject matter to collaboration server 401. If collaboration server 406 did aid in determining the subject matter for graphic 902, the information needed for collaboration server 406 to identify the subject matter context for the communication may already be available to server 406. Thus, depending on which system determines the subject matter, collaboration server 406 may receive information associated with the location of cursor 901 before or after the display of graphic 902.

In alternative examples, had the customer selected video instead, then window 1001 would display video for the communication instead of a text chat. Likewise, an indication of voice call status may be displayed in window 1001 had the user selected voice communication. Further examples may allow a combination of communication modes, such as video and text in combination.

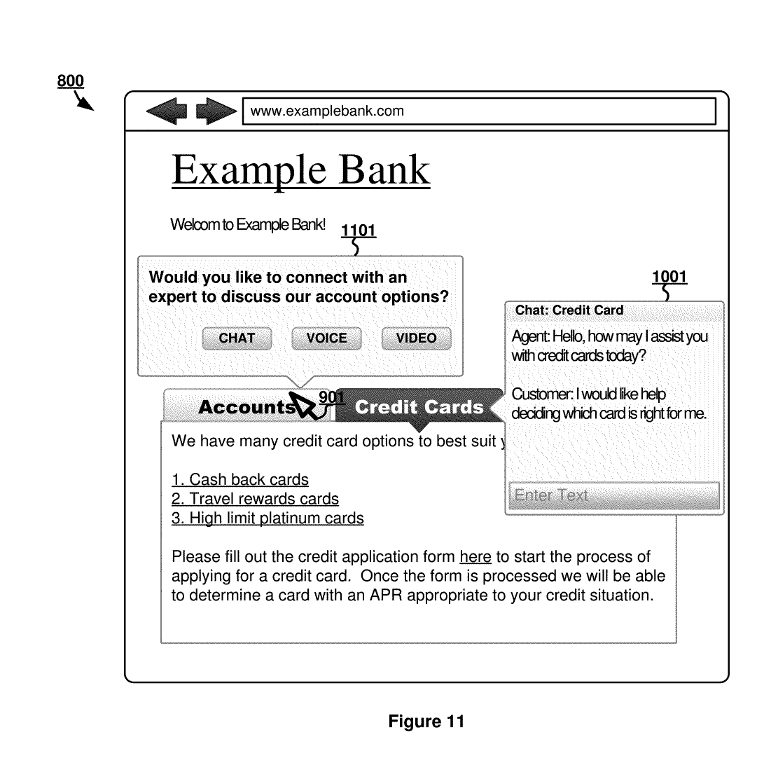

FIG. 11 illustrates web browser window 800 allowing for a second communication. As shown, chat window 1001 is still displayed in window 800. The user subsequently moves cursor 901 to a position near the accounts tab of Example Bank's website. Like what occurred in FIG. 9, using the operations described herein, the subject matter at the location of cursor 901 is determined to be accounts. A graphic 1101 is then presented near the location asking the user whether they would like to start a communication to discuss Example Bank's account offerings.

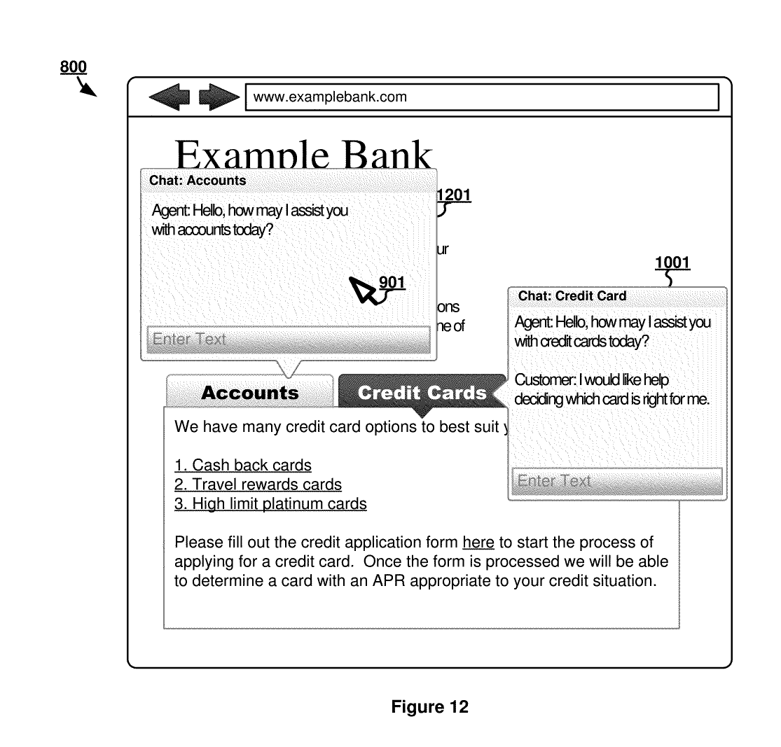

FIG. 12 illustrates web browser window 800 upon the user selecting the text chat option from graphic 1101. Upon receiving the user selection, chat window 1201 is displayed in addition to chat window 1001, with each chant window positioned on the webpage nearby the location from which the context was determined. If the user were to scroll the webpage up and down, the chat windows may remain nearby their respective locations and may therefore scroll into and out of window 800. Since each chat window is positioned near the subject matter on the webpage from which the context of the communication was determined, the user can easily identify which chat window corresponds to which location subject matter. Additionally, the user may be able to move windows 1001 and 1201 from their default locations over the webpage if the user so chooses.

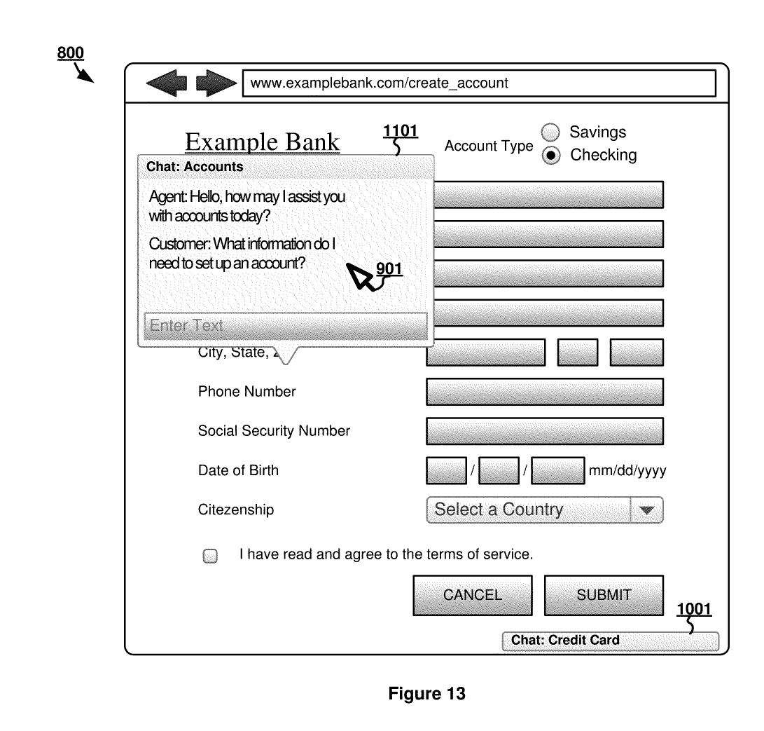

FIG. 13 illustrates web browser window 800 after the user has navigated to a different webpage of Example Bank's website. In particular, the user has decided to set up an account and has therefore navigated to the webpage having a form to apply for an account. The two communications that were present in FIG. 12 persist onto this new webpage in this example. However, since the locations from which the contexts of the communications were determined are no longer displayed, the locations of communication windows 1201 and 1001 are no longer tied to those locations on the new webpage. Moreover, in this particular example, communication window 1001 has been minimized, either by the user or otherwise, as credit cards may not be a priority on this new webpage.

It should be understood that many other ways exist beyond the examples disclosed in FIGS. 8-13 to present in-place communication functionality to a user. The examples of FIGS. 8-13 are merely used to aid in understanding of the in-place communication concept. Additionally, while the communications displayed at the agent's system were not discussed, the agent system may display communication windows to the agent in a similar manner. For example, in a co-browsing type scenario, the agent system may display the same webpage as the user system and may present an in-place communication window near the subject matter location just as the user system does. Standard communication windows displaying the subject matter context may also be used. For example, an agent may have multiple communication windows with multiple users and each communication may be a different context. The context of a communication may be presented to the agent in the communication window, in a notification before the start of the communication, or by some other means.

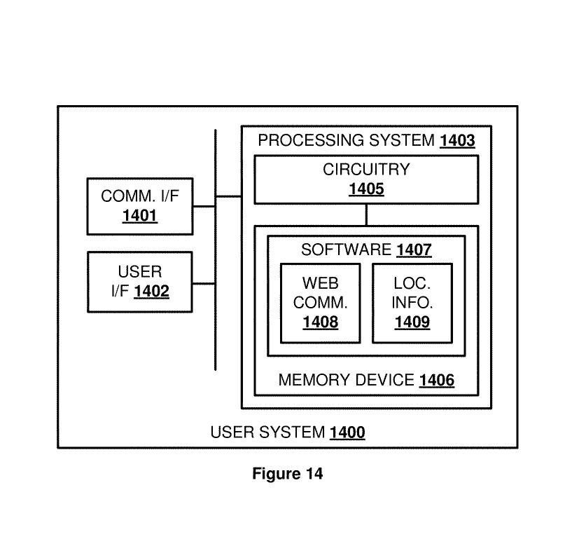

FIG. 14 illustrates user system 1400. User system 1400 is an example of user systems 101 and 102, although devices 101 and 102 could use alternative configurations. User system 1400 comprises communication interface 1401, user interface 1402, and processing system 1403. Processing system 1403 is linked to communication interface 1401 and user interface 1402. Processing system 1403 includes processing circuitry 1405 and memory device 1406 that stores operating software 1407. User system 1400 may include other well-known components such as a battery and enclosure that are not shown for clarity. User system 1400 may be a telephone, computer, e-book, mobile Internet appliance, media player, game console, wireless network interface card, conference room system, or some other communication apparatus—including combinations thereof.

Communication interface 1401 comprises components that communicate over communication links, such as network cards, ports, RF transceivers, processing circuitry and software, or some other communication devices. Communication interface 1401 may be configured to communicate over metallic, wireless, or optical links. Communication interface 1401 may be configured to use TDM, IP, Ethernet, optical networking, wireless protocols, communication signaling, or some other communication format—including combinations thereof.

User interface 1402 comprises components that interact with a user to receive user inputs and to present media and/or information. User interface 1402 may include a speaker, microphone, buttons, lights, display screen, touch screen, touch pad, scroll wheel, communication port, or some other user input/output apparatus—including combinations thereof. User interface 1402 may be omitted in some examples.

Processing circuitry 1405 comprises microprocessor and other circuitry that retrieves and executes operating software 1407 from memory device 1406. Memory device 1406 comprises a non-transitory storage medium, such as a disk drive, flash drive, data storage circuitry, or some other memory apparatus. Processing circuitry 1405 is typically mounted on a circuit board that may also hold memory device 1406 and portions of communication interface 1401 and user interface 1402. Operating software 1407 comprises computer programs, firmware, or some other form of machine-readable processing instructions. Operating software 1407 includes web communication module 1408 and location information module 1409. Operating software 1407 may further include an operating system, utilities, drivers, network interfaces, applications, or some other type of software. When executed by processing circuitry 1405, operating software 1407 directs processing system 1403 to operate user system 1400 as described herein.

Web communication module 1408 directs processing system 1403 to determine that an indicator is positioned by a user of user system 1400 over a first location on a webpage of a website displayed on a display of user interface 1402 and receive a user selection from the user that requests a communication with an agent system. In response to the user selection, location information module 1409 directs processing system 1403 to transfer information via communication interface 1401 associated with the first location to a collaboration system. The collaboration system uses the information to determine a subject matter context for the communication and transfers an indication of the subject matter context to the agent system for use during the communication. The web communication module 1408 further directs processing system 1403 to establish the communication through communication interface 1401 with the agent system via the collaboration system.

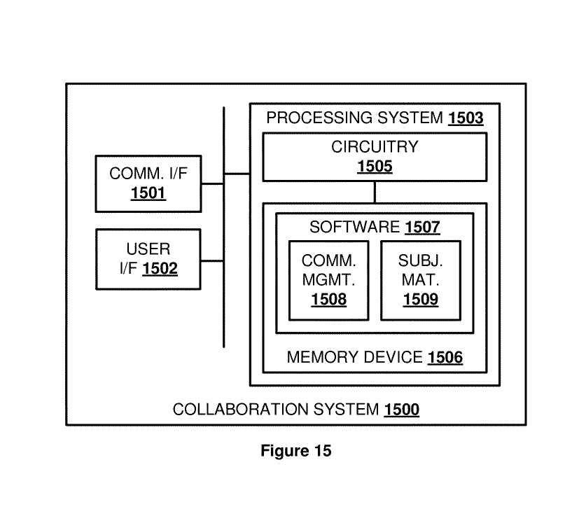

FIG. 15 illustrates collaboration system 1500. Collaboration system 1500 is an example of collaboration system 103, although system 103 may use alternative configurations. Collaboration system 1500 comprises communication interface 1501, user interface 1502, and processing system 1503. Processing system 1503 is linked to communication interface 1501 and user interface 1502. Processing system 1503 includes processing circuitry 1505 and memory device 1506 that stores operating software 1507.

Communication interface 1501 comprises components that communicate over communication links, such as network cards, ports, RF transceivers, processing circuitry and software, or some other communication devices. Communication interface 1501 may be configured to communicate over metallic, wireless, or optical links. Communication interface 1501 may be configured to use TDM, IP, Ethernet, optical networking, wireless protocols, communication signaling, or some other communication format—including combinations thereof.

User interface 1502 comprises components that interact with a user. User interface 1502 may include a keyboard, display screen, mouse, touch pad, or some other user input/output apparatus. User interface 1502 may be omitted in some examples.

Processing circuitry 1505 comprises microprocessor and other circuitry that retrieves and executes operating software 1507 from memory device 1506. Memory device 1506 comprises a non-transitory storage medium, such as a disk drive, flash drive, data storage circuitry, or some other memory apparatus. Operating software 1507 comprises computer programs, firmware, or some other form of machine-readable processing instructions. Operating software includes communication management module 1508 and subject matter module 1509. Operating software 1507 may further include an operating system, utilities, drivers, network interfaces, applications, or some other type of software. When executed by circuitry 1505, operating software 1507 directs processing system 1503 to operate collaboration system 1500 as described herein.

In particular, communication management module 1508 directs processing system 1503 to, in response to a user selection from a user of a user system that requests a communication with an agent system, receive information via communication interface 1501 associated with a first location on a webpage of a website displayed on the user system over which an indicator is positioned by the user. Subject matter module 1509 directs processing system 1503 to determine a subject matter context for the communication using the information and transfer via communication interface 1501 an indication of the subject matter context to the agent system for use during the communication. Communication management module 1508 further directs processing system 1503 to establish the communication between the user system and the agent system.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A non-transitory computer readable storage medium having instructions stored thereon that, when executed by a user system, direct the user system to perform a method of facilitating an in-place web communication related to content of a webpage, the method comprising:
determining that an indicator is positioned by a user of the user system over a first location on a webpage of a website displayed on the user system;
receiving a user selection from the user that requests a communication with an agent system;
in response to the user selection, transferring information associated with the first location to a collaboration system, wherein the collaboration system uses the information to determine a subject matter context for the communication and transfers an indication of the subject matter context to the agent system for use during the communication; and
establishing the communication with the agent system via the collaboration system.

2. The non-transitory computer readable storage medium of claim 1, wherein the method further comprises:
in response to determining that the indicator is positioned over the first location, displaying a selectable graphical element through which the user selection is received.

3. The non-transitory computer readable storage medium of claim 1, wherein the collaboration system stores a recording of the communication for future access.

4. The non-transitory computer readable storage medium of claim 3, wherein the method further comprises:
after the communication, displaying the webpage at a second time, receiving the recording of the communication from the collaboration system, and presenting the recording to the user in relation to the first location.

5. The non-transitory computer readable storage medium of claim 1, wherein the method further comprises:
displaying a second webpage of the website on the user system; and
continuing the communication on the second webpage.

6. The non-transitory computer readable storage medium of claim 1, wherein the method further comprises:
determining that the indicator is positioned by the user over a second location on the webpage;
receiving a second user selection from the user that requests a second communication with a second agent system;
in response to the second user selection, transferring second information associated with the second location to the collaboration system, wherein the collaboration system uses the second information to determine a second subject matter context for the second communication and transfers an indication of the second subject matter context to the second agent system for use during the second communication; and
establishing the second communication with the second agent system via the collaboration system.

7. The non-transitory computer readable storage medium of claim 1, wherein the communication begins in a first medium and the method further comprising:
receiving an instruction to change the communication to a second medium; and
continuing the communication in the second medium.

8. A non-transitory computer readable storage medium having instructions stored thereon that, when executed by a collaboration system, direct the collaboration system to perform a method of facilitating an in-place web communication related to content of a webpage, the method comprising:
in response to a user selection from a user of a user system that requests a communication with an agent system, receiving information associated with a first location on a webpage of a website displayed on the user system over which an indicator is positioned by the user;
determining a subject matter context for the communication using the information;
transferring an indication of the subject matter context to the agent system for use during the communication; and
establishing the communication between the user system and the agent system.

9. The non-transitory computer readable storage medium of claim 8, wherein the user system displays a selectable graphical element through which the user selection is received.

10. The non-transitory computer readable storage medium of claim 8, wherein the method further comprises:
storing a recording of the communication for future access.

11. The non-transitory computer readable storage medium of claim 10, wherein after the communication, the user system displays the webpage at a second time, and the method further comprising:
transferring the recording of the communication from the collaboration system to the user system for presenting the recording to the user in relation to the first location.

12. The non-transitory computer readable storage medium of claim 8, wherein the user system displays a second webpage of the website and the method further comprises:
continuing the communication with the user system on the second webpage.

13. The non-transitory computer readable storage medium of claim 8, wherein the method further comprises:
in response to a second user selection from the user that requests a second communication with a second agent system, receiving second information associated with a second location on the webpage over which the indicator is positioned by the user;
determining a second subject matter context for the second communication using the second information;
transferring an indication of the second subject matter context to the second agent system for use during the second communication; and
establishing the second communication between the user system and the second agent system.

14. The non-transitory computer readable storage medium of claim 8, wherein the communication begins in a first medium and the method further comprising:
receiving an instruction to change the communication to a second medium; and
continuing the communication in the second medium.

15. A collaboration system for facilitating an in-place web communication related to content of a webpage, the collaboration system comprising:
a communication interface configured to, in response to a user selection from a user of a user system that requests a communication with an agent system, receive information associated with a first location on a webpage of a website displayed on the user system over which an indicator is positioned by the user and transfer an indication of a subject matter context for the communication to the agent system for use during the communication; and
a processing system configured to determine the subject matter context using the information and establish the communication between the user system and the agent system.

16. The collaboration system of claim 15, wherein the user system displays a selectable graphical element through which the user selection is received.

17. The collaboration system of claim 15, further comprising:
a storage system configured to store a recording of the communication for future access.

18. The collaboration system of claim 17, wherein after the communication, the user system displays the webpage at a second time, and the collaboration system further comprising:
the communication interface configured to transfer the recording of the communication to the user system for presenting the recording to the user in relation to the first location.

19. The collaboration system of claim 15, wherein the user system displays a second webpage of the website and the collaboration system further comprising:
the processing system configured to continue the communication with the user system on the second webpage.

20. The collaboration system of claim 15, further comprising:
the communication interface configured to, in response to a second user selection from the user that requests a second communication with a second agent system, receive second information associated with a second location on the webpage over which the indicator is positioned by the user and transfer an indication of a second subject matter context for the second communication to the second agent system for use during the second communication;
the processing system configured to determine the second subject matter context using the second information and establish the second communication between the user system and the second agent system.
